(19) United States
(12) Patent Application Publication
(10) Pub. No.: US 2020/0080474 A1
(43) Pub. Date: Mar. 12, 2020

(54) Runaway Diesel Suppressor System

(71) Applicant: Thomas MORE, Pleasantville, NY (US)

(72) Inventor: Thomas MORE, Pleasantville, NY (US)

(21) Appl. No.: 16/539,657

(22) Filed: Aug. 13, 2019

Related U.S. Application Data
(60) Provisional application No. 62/718,159, filed on Aug. 13, 2018.

(51) Int. Cl. F02B 77/08; F02M 35/10; F02M 25/00; B60K 13/02; F02B 47/04; F02D 41/22; F02D 41/00

(52) U.S. Cl. CPC F02B 77/08; F02M 35/10209; F02M 25/00; B60K 13/02; F02D 2200/101; F02B 47/04; F02D 41/22; F02D 41/0025; F02M 35/10255

(57) ABSTRACT

A system for suppressing a runaway diesel engine condition includes a vessel containing a suppressor gas and a valve assembly having a main conduit which is fluidly connected to the vessel. The valve assembly includes a valve that is movable between an open position and a closed position. At least one nozzle is for placement in fluid communication with an inside of an air intake system that is part of a diesel engine. The at least one nozzle is in fluid communication with the main conduit such that when the valve is in the open position, the suppressor gas flows through the valve to the nozzle where it is discharged through the at least one nozzle into the air intake system. An actuator is operably connected to the valve for causing the valve to move between the open position and the closed position.

### CROSS REFERENCE TO RELATED APPLICATION

The present application claims priority to and the benefit of U.S. patent application No. 62/718,159, filed Aug. 13, 2018, which is hereby incorporated by reference in its entirety.

### TECHNICAL FIELD

The present invention relates to diesel engines and more particularly, relates to a system for suppressing a “runaway diesel engine” condition.

### BACKGROUND

A “runaway diesel engine” is a condition that can affect any turbocharged diesel engine if the oil seal inside the turbo fails. Upon failure of the seal while the engine is running, engine lubricating oil will be sucked through the engine air intake into the combustion chambers of the engine causing the engine RPM to surge to either at redline, or in many cases beyond the redline. The engine will continue to run at full speed until it either seizes by lack of lubricating oil, blows its internal parts by extreme stress from running at such a high RPM, or is shut down manually. Currently, there is no way to manually shut down a runaway diesel engine aside from manually discharging a carbon dioxide fire extinguisher into the intake, or by stuffing foreign objects, such as rags into the air box. This can be a dangerous situation considering the engine is running at a very high engine-speed and could potentially blow internal parts through the engine block.

There is therefore a need for an alternative safety system and method for suppressing the runaway diesel engine condition.

### SUMMARY

The purpose of this invention is to counter a “runaway diesel” condition on diesel engines, on-road, off-road or on generators or any application where there is a diesel engine.

A system for suppressing a runaway diesel engine condition includes a vessel containing a suppressor gas and a valve assembly having a main conduit which is fluidly connected to the vessel. The valve assembly includes a valve that is movable between an open position and a closed position. At least one nozzle is for placement in fluid communication with an inside of an air intake system that is part of a diesel engine. The at least one nozzle is in fluid communication with the main conduit such that when the valve is in the open position, the suppressor gas flows through the valve to the nozzle where it is discharged through the at least one nozzle into the air intake system. An actuator is operably connected to the valve for causing the valve to move between the open position and the closed position.

### BRIEF DESCRIPTION OF DRAWING FIGURES

FIG. 1 is a schematic illustrating a system for suppressing a runway diesel engine condition in accordance with one embodiment;

FIG. 2 is a close-up view of a valve assembly thereof;

FIG. 3 is a close-up view of the interface between the system and an engine air intake conduit; and

FIG. 4 is a schematic illustrating a system for suppressing a runway diesel engine condition in accordance with another embodiment.

### DETAILED DESCRIPTION OF CERTAIN EMBODIMENTS

The present invention is directed to a system, generally shown at 10, that is configured to suppress a runaway diesel engine condition. As described herein, the system 10 is designed to be fitted into a vehicle that has a diesel engine or can be designed to work with other applications in which a diesel engine is employed.

The system 10 includes a vessel 400 that can be in the form of a tank that holds a fluid, such a suppressor gas and more particularly, the vessel 400 can contain a pressurized neutral gas, such as argonite, or argon, that will displace oxygen inside an internal combustion engine when introduced into the intake system of the engine. The suppressor gas is delivered into the intake system by means of one or more spray nozzles 700 and preferably, there is at least two spray nozzles 700 as shown. As described herein, the spray nozzles 700 are disposed and oriented so that they deliver, in a controlled manner, the suppressor gas into the intake system. As described herein, the spray nozzles 700 are in fluid communication with the suppressor gas contained in the vessel 400.

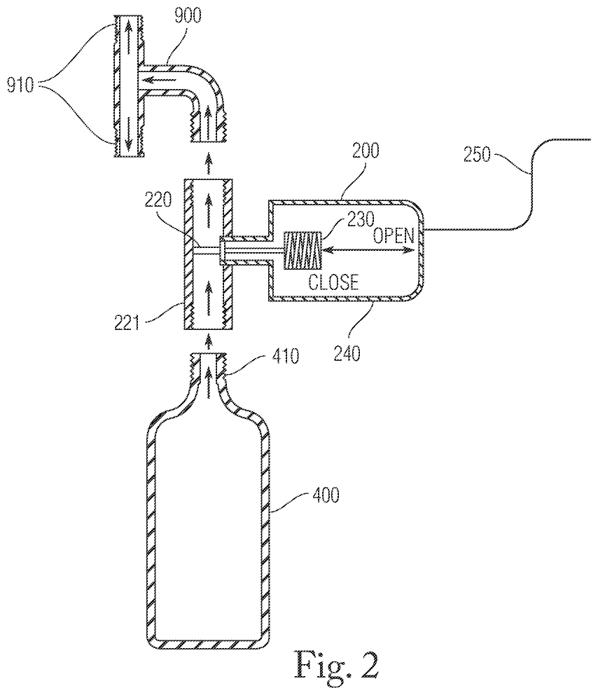

The system 10 includes a valve assembly, generally shown at 200, which is used to control the flow of the suppressor gas from the vessel 400 and in particular, is designed to permit the suppressor gas to flow when the valve assembly 200 is in the open position and prevents the suppressor gas from flowing when the valve assembly 200 is in the closed position. FIG. 2 shows additional details of one exemplary valve assembly 200 and according to one exemplary embodiment, the valve assembly 200 can be in the form of a plunger-style solenoid valve 220 that is contained within a valve assembly housing 240. The valve assembly 200 is constructed so that it sealingly mates with the open end of the vessel 400. For example, the open end of the vessel 400 can be threadingly coupled to a conduit 221 of the valve assembly 200 to allow the suppressor gas to flow directly from the interior of the vessel 400 to the conduit 221 and be acted upon by the solenoid valve 220 which extends into the conduit 221 at least in the closed position of the solenoid valve 220.

In FIG. 2, the direction of movement of the solenoid valve 220 is shown by the directional arrow and the words “open” and “close”.

The solenoid valve 220 includes an electro-magnetic actuator (230) powered by a main power cable (250) that leads to a power source, such as a charging system or battery of a vehicle or other power source (e.g., electrical outlet). Other working components, such as a processor, can be likewise charged and powered. As known in a traditional solenoid valve, an electric current through the coil creates a magnetic field. The magnetic field exerts a force on the plunger. As a result, the plunger is pulled toward the center of the coil so that the orifice opens. This is the basic principle that is used to open and close solenoid valves.

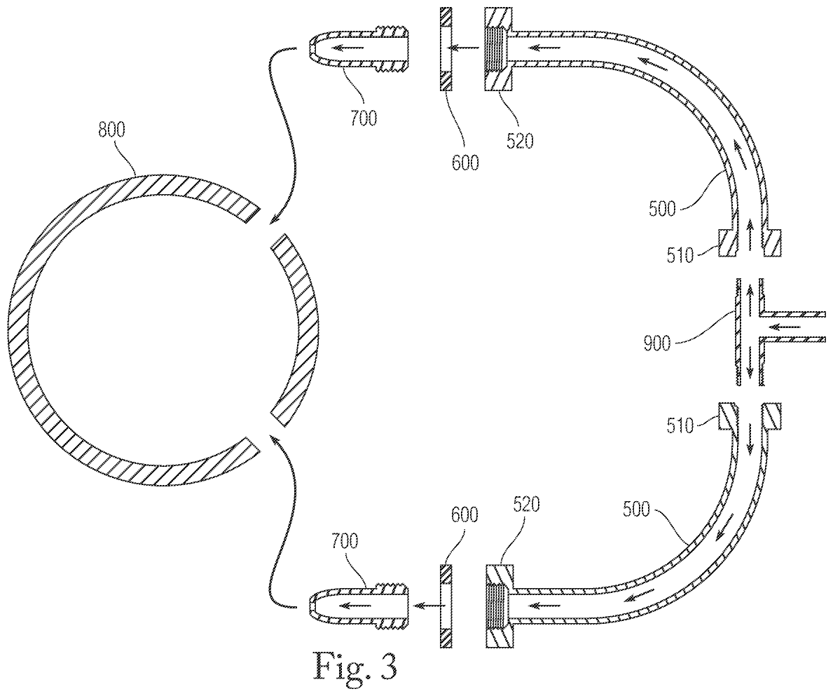

The vessel 400 connects to the conduit 221 at one end, while at the opposite end of the conduit 221, a connector or fitting 900 is fluidly and sealingly coupled thereto for receiving the suppressor gas once the solenoid valve 220 is opened. The connector 900 can take any number of different forms depending upon the surrounding architecture and in particular, depending upon the number of nozzles 700. In the illustrated embodiment, the connector 900 comprises a Tee fitting/connector with a first leg connected to the open end of the conduit 221 and second and third legs being open and being fluidly and sealingly connected to a pair of conduits 500. The conduits 500 are in the form of suitable hoses that fluidly connect to the nozzles 700. FIG. 3 shows additional details of these conduits. Each conduit 500 has a first end 510 that is coupled to the connector 900 and an opposing second end 520 that is fluidly connected to the nozzle 700. A rubber seal 600 or the like can be disposed between the second end 520 and the nozzle 700 to provide a sealed interface.

The nozzles 700 are disposed such that they are in fluid communication with the inside of an air intake conduit (tube) 800 of the diesel engine. More particularly, the air intake conduit 800 has an opening formed in its outer wall to receive one nozzle 700 (thus, there are two openings to accommodate two nozzles) and rubber seal 600 is disposed within these openings formed in the air intake conduit 800. The nozzles 700 are positioned in the air intake conduit 800 at locations downstream of the air filter that is part of the air intake system.

The suppressor gas is released through the nozzles 700, which are seated into, or threaded into the air intake conduit 800 with the flat rubber seal 600 to prevent outside air from bypassing the air filter and entering the engine intake.

As previously mentioned, the solenoid valve 200 includes a main power supply (battery or part of the vehicle's power system) that supplies power to, and activates the plunger-type solenoid valve 220, releasing the gas through the hoses 500 to the nozzles 700, thereby delivering the suppressor gas directly into the air-intake tube 800.

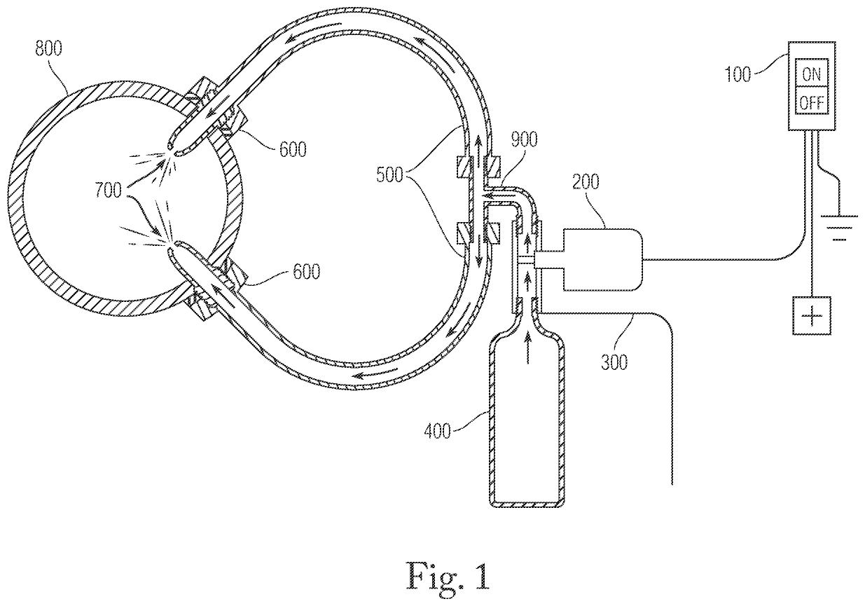

As shown in FIG. 1, the system 10 includes an actuator 100 for controllably operating the system 10 and causing the release of the suppressor gas. The actuator 100 can be any number of different types of actuators including those that are hard wired to the solenoid valve 220 and those that are in wireless communication (e.g., Bluetooth) with the solenoid valve 220. In one embodiment, the actuator 100 can be in the form of a button or switch (such as an on/off flip switch) that is mounted somewhere either in the cab of the vehicle or machine, or on a control panel in the case of generators, compressors, etc. that are based on diesel engines. In the event of wireless, the change in state of the switch 100 is conveyed wirelessly to the valve 220 to control its operating state.

As shown in FIG. 1, the main valve (solenoid valve 200) can be mounted on, or near the firewall or main control panel of the vehicle or application to which it can be affixed with a suitable mount, such as an “L” bracket 300. Each of the two conduits 500 for the system 10 can have a female pipe thread fitting pressed onto them at each end 510, 520. The hoses 500 and fittings preferably all contain O-rings 910 to further seal the system 10.

Method for Suppressing:

The present invention is a system which is operator or driver applied at the first sign of a runaway condition by activating the actuator 100 in the cab, or on control panel in the event of a generator or the like. The suppressor gas from the vessel 400 is released via the solenoid valve 200, which internally contains the electro-magnetic actuator 230 powered by the main power cable 250 or the like, and enters the intake of the engine through the nozzles 700, and from there will be sucked into the combustion chambers of the engine through the air intake 800, suffocating it. Once the engine has been safely shut-down, the operator could either shut the valve by pushing back the switch 100, or could leave open to discharge the remainder of the gas if necessary. The refillable vessel 400 can then be removed and refilled at a station that sells this type of gas (such as a welding supply store).

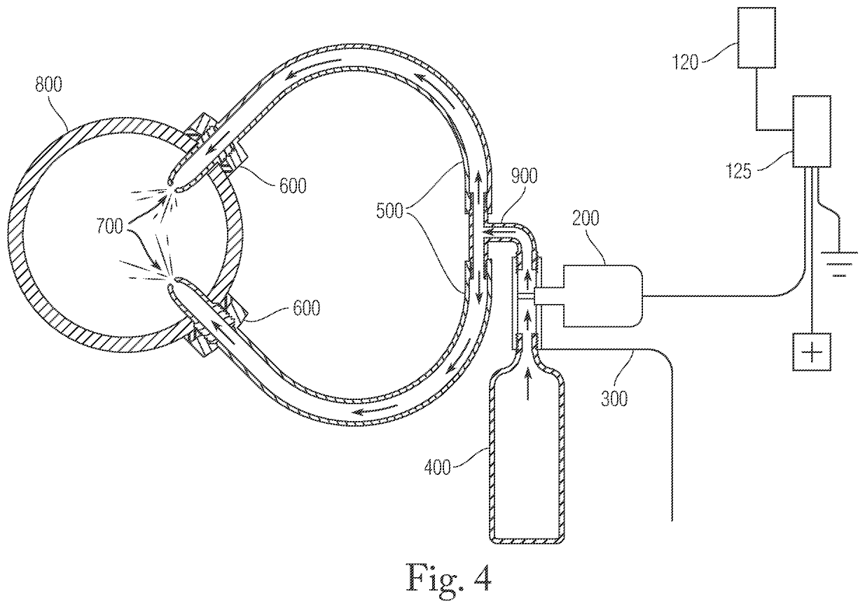

FIG. 4 is similar to the previous embodiment and therefore, like elements are numbered alike. FIG. 4 illustrates a small vessel (400) that will contain a pressurized neutral gas such as argonite, or argon that will displace oxygen inside an internal combustion engine when introduced into the intake system through a set of two or more spray nozzles (700). The gas coming from the vessel will travel through a plunger-style solenoid valve (200,220) into which the vessel is threaded with a rubber O-ring (410). From the valve, the gas will travel into a T-style fitting (900), and then into two hoses (500) that will travel to the outside of the engine-air intake tube (800), into which the nozzles will be threaded through a rubber seal (600) post filter. The gas will be released through the nozzles (700), which will be seated into, or threaded into the intake tube with a flat rubber seal (600) to prevent outside air from bypassing the air filter and entering the engines intake. There will also be a main power supply to the solenoid valve (200) that will supply power to, and activate the plunger valve, releasing the gas through the hoses. The button itself (in the case of a manually activated switch) would be mounted either somewhere in the cab of the vehicle or machine, or on the control panel in the case of generators, compressors, etc. In the case of an automatically engaged switch 120 (RPM switch)(actuator), the switch 120 can be mounted anywhere on the vehicle or control panel, or on the engine itself depending on application since it does not require user interaction. The main valve of this invention will be mounted on, or near the firewall or main control panel of the vehicle or application to which it will be affixed with an “L” bracket (300). Each of the two hoses for this system will have a female pipe thread fitting pressed onto them at each end (510,520). The hoses and fittings will all contain O-rings (910) to further seal the system.

The system is either operator or driver applied at the first sign of a runaway condition by activating the switch (on/off switch 100 in FIG. 1) in the cab, or control panel in the case of a manually operated system. In the case of automatic system, the suppressor system will engage via an RPM based switch (actuator) 120 (FIG. 4) that is configured such that once the detected RMP is above a pre-set value, such as above redline RPM, and is held above this pre-set RPM value for a pre-set amount of time (that will vary depending on what application the device is affixed to), the actuator signals the solenoid valve 220 to activate (open), thereby releasing the gas through the hoses 500 to the nozzles 700, thereby delivering the suppressor gas directly into the air-intake tube 800. The prescribed RPM range and pre-set amount of time are selected values that are indicative of a runaway engine event as opposed to a discrete overrev situation or other split second events in which the engine is revved to redline, etc.

In other words, the switch 120 is not user actuated but is based on RPM feedback (from an RPM sensor 125) and once a controller (PCB) detects from the RPM sensor that the RPM exceeds a threshold (pre-set) RPM (such as a redline RPM for the engine), the solenoid 220 is controlled so as to open and release the suppressor gas. This action requires no user input but rather is based solely on RPM detection where said RPM event (such as being at redline for a period of time) is indicative of a runaway engine event. It will be appreciated that any number of traditional RPM sensors can be used, such as a magnetic based RPM sensor (e.g., Hall sensor) or an optical based RPM sensor that detects engine speed (RPMs of crankshaft).

When using the automated switch 120, the processor receives the measurement data from the sensor 125 and communicates with the switch 120 (actuator) to cause it to signal the opening of the valve 200 under select prescribed events such as the high RPM detection over the prescribed time period as mentioned above). The processor is thus also in communication with valve 200 for controlled operation thereof.

The gas from the vessel will be released via the solenoid valve 200, which internally contains an electro-magnetic actuator 230 (FIG. 2) powered by the main power cable 250, and is covered for protection with a covering 240, and enter the intake of the engine through the nozzles 700, and from there will be sucked into the combustion chambers of the engine through the air intake 800, suffocating it. Once the engine has been safely shut down, the operator can either shut the valve 200 by changing the operating state of the switch 100 (i.e., closing the switch), or could leave it open to discharge the remainder of the gas if necessary. In the case of an automatic system, the switch 120 will either remain open, or shut (closed) once the engine RPM has dropped to zero (or a pre-set value depending on specific application to which the device will be affixed). The refillable vessel can then be removed and refilled at a station that sells this type of gas (such as a welding supply store).

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments will so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

What is claimed is:

1. A system for suppressing a runaway diesel engine condition comprising:
a vessel containing a suppressor gas;
a valve assembly having a main conduit which is fluidly connected to the vessel, the valve assembly including a valve that is movable between an open position and a closed position;
at least one nozzle that is for placement in fluid communication with an inside of an air intake system that is part of a diesel engine, the at least one nozzle being in fluid communication with the main conduit such that when the valve is in the open position, the suppressor gas flows through the valve to the nozzle where it is discharged through the at least one nozzle into the air intake system; and
an actuator operably connected to the valve for causing the valve to move between the open position and the closed position.

2. The system of claim 1, wherein the vessel comprises a tank.

3. The system of claim 1, wherein the valve comprises a solenoid valve that is contained within a housing.

4. The system of claim 3, wherein the solenoid valve comprises a plunger-type valve that extends into the main conduit.

5. The system of claim 1, further including a connector that is in fluid communication with the main conduit, the connector having first and second legs that are in fluid communication with conduits that lead to a pair of nozzles that are configured to be sealingly inserted into the air intake system.

6. The system of claim 1, wherein the air intake system includes an air intake tube.

7. The system of claim 1, wherein the actuator comprises a switch.

8. An air intake system that includes a diesel engine and an air intake system in which air is received for delivery to the diesel engine, comprising:
a safety system for suppressing a runaway diesel engine condition in the diesel engine, the safety system comprising:
a vessel containing a suppressor gas;
a valve assembly having a main conduit which is fluidly connected to the vessel, the valve assembly including a valve that is movable between an open position and a closed position;
at least one nozzle that is for placement in fluid communication with an inside of the air intake system that is part of a diesel engine, the at least one nozzle being in fluid communication with the main conduit such that when the valve is in the open position, the suppressor gas flows through the valve to the nozzle where it is discharged through the at least one nozzle into the air intake system; and
an actuator operably connected to the valve for causing the valve to move between the open position and the closed position.

9. The air intake system of claim 8, wherein the diesel engine is part of a vehicle.

10. The air intake system of claim 8, wherein the air intake system comprises an air intake tube into which the at least one nozzle is inserted for delivering the suppressor gas to an inside of the air intake tube.

11. A method for suppressing a runaway engine condition in a diesel engine comprising the steps of:
injecting a suppressor gas into an air intake system of the diesel engine by actuating a valve to cause the valve to open, thereby allowing suppressor gas to be delivered from a vessel that is mounted to a frame in which the diesel engine is contained.
